(19) United States
(12) Patent Application Publication
(10) Pub. No.: US 2025/0347614 A1
(43) Pub. Date: Nov. 13, 2025

(54) DEPLOYMENT METHODS AND SYSTEMS FOR PIPELINE PROTECTION COMPONENTS BASED ON SMART GAS INTERNET OF THINGS (IOT)

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/274,662

(22) Filed: Jul. 21, 2025

(30) Foreign Application Priority Data
Jul. 1, 2025 (CN) 202510903214.8

(51) Int. Cl. G01N 17/04; G06Q 50/26; G16Y 40/35; G16Y 40/50

(52) U.S. Cl. CPC G01N 17/04; G06Q 50/26; G16Y 40/35; G16Y 40/50

(57) ABSTRACT

Disclosed are a deployment method and a deployment system for a pipeline protection component based on a smart gas IoT. The method includes: obtaining environmental information of a target region during a plurality of first preset time periods; obtaining biological information, climate information, and facility information of the target region; determining a vibration risk value of the target region; determining a target risk distribution of the target region; determining target protection component information of a target protection component deployed at each of a plurality of acquisition points in the target region; determining a deployment density distribution of the target protection components based on the target risk distribution and a pipeline deployment map of the target region; before and/or executing a protection component deployment operation, generating a valve control instruction to regulate a gas delivery pressure of at least one gas pipeline in the target region.

### CROSS-REFERENCE TO RELATED APPLICATIONS

This application claims priority to Chinese Patent Application No. 202510903214.8, filed on Jul. 1, 2025, the entire contents of which are hereby incorporated by reference.

### TECHNICAL FIELD

The present disclosure relates to the field of gas pipeline management, and in particular, to deployment methods and systems for pipeline protection components based on smart gas Internet of Things (IoT).

### BACKGROUND

Gas pipelines are the primary transportation infrastructure for gas. During operation, external interferences such as temperature variations, mechanical stress, vibration, freeze-thaw cycles, and biological corrosion may reduce the service life of gas pipelines or even cause pipeline failures, posing safety hazards. In existing technologies, the management and maintenance of gas pipelines primarily rely on a combination of periodic inspections and post-failure repairs, lacking proactive preventive measures during pipeline installation.

Therefore, it is desirable to provide a deployment method and a deployment system for a pipeline protection component based on a smart gas Internet of Things (IoT). The method and the system can deploy corresponding pipeline protection components in key protection regions during pipeline installation based on actual conditions, thereby extending the service life of gas pipelines and ensuring the operational safety of gas pipeline management.

### SUMMARY

One or more embodiments of the present disclosure provide a deployment method for a pipeline protection component based on a smart gas IoT. The method is executed by a gas company management platform of a deployment system for the pipeline protection component, the method including: obtaining, via a gas company sensor network platform, environmental information of a target region during a plurality of first preset time periods from a sensing device arranged in a gas device object platform, the environmental information including temperature information, humidity information, geological information, and vibration information; obtaining, via a governmental safety monitoring sensor network platform, biological information, climate information, and facility information of the target region during the plurality of first preset time periods from a governmental safety monitoring management platform; determining, based on the geological information, the facility information, and the vibration information during the plurality of first preset time periods, a vibration risk value of the target region during each of the plurality of first preset time periods; determining, based on the geological information, the biological information, and the facility information during the plurality of first preset time periods, a corrosion risk value of the target region during each of the plurality of first preset time periods; determining, based on the climate information during the plurality of first preset time periods, a temperature risk value of the target region during each of the plurality of first preset time periods; determining, based on the vibration risk value, the corrosion risk value, and the temperature risk value of the target region during each of the plurality of first preset time periods, a target risk distribution of the target region; determining, based on the target risk distribution, target protection component information of a target protection component deployed at each of a plurality of acquisition points in the target region, the target protection component information including a target protection component type of the target protection component and a first target protection level corresponding to the target protection component; determining, based on the target risk distribution and a pipeline deployment map of the target region, a deployment density distribution of the target protection components at the plurality of acquisition points in the target region; and before executing a protection component deployment operation, and/or during the execution of the protection component deployment operation, generating a valve control instruction based on the deployment density distribution, and sending the valve control instruction to the gas device object platform to regulate a gas delivery pressure of at least one gas pipeline in the target region.

One or more embodiments of the present disclosure provide a deployment system for a pipeline protection component based on a smart gas IoT. The deployment system for the pipeline protection component includes a governmental safety monitoring management platform, a governmental safety monitoring sensor network platform, a governmental safety monitoring object platform, a gas company sensor network platform, and a gas device object platform, wherein the governmental safety monitoring object platform includes a gas company management platform; the gas company management platform includes at least one processor and at least one storage device; the at least one storage device is configured to store computer instructions; the at least one processor is configured to execute at least a portion of the computer instructions to: obtain, via the gas company sensor network platform, environmental information of a target region during a plurality of first preset time periods from a sensing device provided in the gas device object platform, the environmental information including temperature information, humidity information, geological information, and vibration information; obtain, via the governmental safety monitoring sensor network platform, biological information, climate information, and facility information of the target region during the plurality of first preset time periods from the governmental safety monitoring management platform; determine, based on the geological information, the facility information, and the vibration information during the plurality of first preset time periods, a vibration risk value of the target region during each of the plurality of first preset time periods; determine, based on the geological information, the biological information, and the facility information during the plurality of first preset time periods, a corrosion risk value of the target region during each of the plurality of first preset time periods; determine, based on the climate information during the plurality of first preset time periods, a temperature risk value of the target region during each of the plurality of first preset time periods; determine, based on the vibration risk value, the corrosion risk value, and the temperature risk value of the target region during each of the plurality of first preset time periods, a target risk distribution of the target region; determine, based on the target risk distribution, target protection component information of a target protection component at each of a plurality of acquisition points in the target region, the target protection component information including a target protection component type of the target protection component and a first target protection level corresponding to the target protection component; determine, based on the target risk distribution and a pipeline deployment map of the target region, a deployment density distribution of the target protection components at the plurality of acquisition points in the target region; and before executing a protection component deployment operation, and/or during the execution of the protection component deployment operation, generate a valve control instruction based on the deployment density distribution, and send the valve control instruction to the gas device object platform to regulate a gas delivery pressure of at least one gas pipeline in the target region.

One or more embodiments of the present disclosure provide a non-transitory computer readable storage medium. The computer-readable storage medium stores computer instructions, and when a processor executes the computer instructions in the storage medium, the processor implements the deployment method for the pipeline protection component based on the smart gas IoT as described in any of the embodiments of the present disclosure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, where like reference numerals represent similar structures throughout the several views of the drawings, and wherein:

FIG. 1 is an exemplary schematic diagram illustrating a smart gas IoT according to some embodiments of the present disclosure;

FIG. 2 is an exemplary flowchart illustrating a process of a deployment method for a pipeline protection component based on a smart gas IoT according to some embodiments of the present disclosure; and

FIG. 3 is an exemplary schematic diagram illustrating the determination of target protection component information according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” as used in the claims and the specification includes any and all combinations of one or more of the associated listed items. It may be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It may be understood that the terms “system,” “engine,” “unit,” “module,” and/or “block” used herein are one method to distinguish different components, elements, parts, sections, or assemblies of different levels in ascending order. However, the terms may be displaced by another expression if they achieve the same purpose.

It may be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

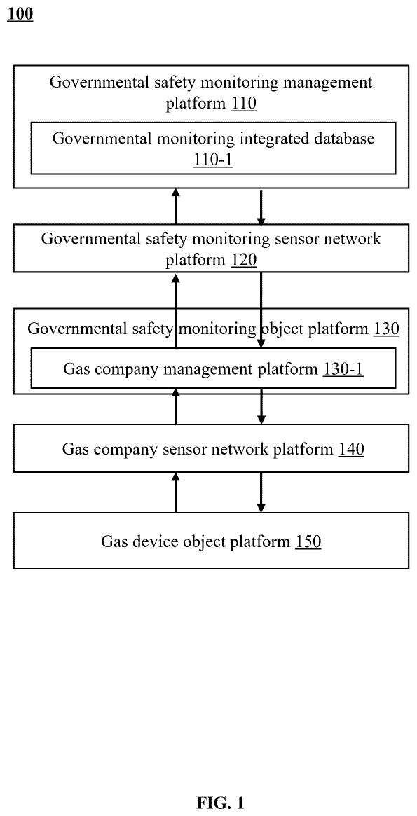

FIG. 1 is an exemplary schematic diagram illustrating a smart gas IoT according to some embodiments of the present disclosure. It should be noted that the following embodiments are only used to explain the present disclosure and do not constitute a limitation of the present disclosure.

As shown in FIG. 1, in some embodiments, a smart gas IoT 100 may include a governmental safety monitoring management platform 110, a governmental safety monitoring sensor network platform 120, a governmental safety monitoring object platform 130, a gas company sensor network platform 140, and a gas device object platform 150.

In some embodiments, information and/or data may be exchanged between one or more platforms in the smart gas IoT 100 via a network. In some embodiments, the network may be any one or more of a wired network and a wireless network.

The governmental safety monitoring management platform 110 refers to an integrated management platform for the government to conduct safety monitoring and management. In some embodiments, the governmental safety monitoring management platform 110 may be configured to process and store data from the smart gas IoT 100.

In some embodiments, the governmental safety monitoring management platform 110 may include a governmental monitoring integrated database 110-1. The governmental monitoring integrated database 110-1 refers to a database that implements data storage.

In some embodiments, the governmental safety monitoring management platform 110 may be configured to obtain biological information, climate information, and facility information of a region in which a plurality of gas pipelines are located during a plurality of time periods in real-time or at a time interval, and store the obtained information in the governmental monitoring integrated database 110-1. More descriptions regarding the governmental safety monitoring management platform 110 may be found in the following related descriptions.

The governmental safety monitoring sensor network platform 120 refers to a functional platform for sensing communication between the governmental safety monitoring management platform 110 and the governmental safety monitoring object platform 130. The governmental safety monitoring sensor network platform 120 may be configured as a communication network and a gateway.

The governmental safety monitoring object platform 130 refers to a platform for safety monitoring of a gas-related object. For example, the gas-related object may include a gas company, or the like. In some embodiments, the governmental safety monitoring object platform 130 may interact with the governmental safety monitoring sensor network platform 120 and the gas company sensor network platform 140 for information exchange.

In some embodiments, the governmental safety monitoring object platform 130 may include a gas company management platform 130-1. The gas company management platform 130-1 refers to an information-integrated management platform for a gas company. For example, the gas company management platform 130-1 may be a processor or a server of the gas company. In some embodiments, the gas company management platform 130-1 may interact with the gas company sensor network platform 140 and the governmental safety monitoring sensor network platform 120.

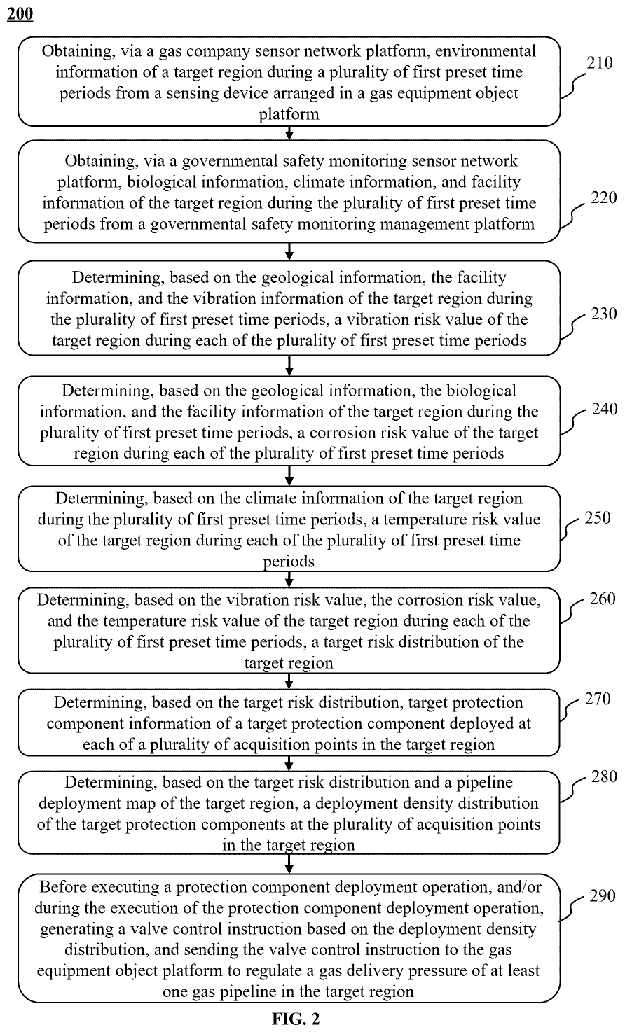

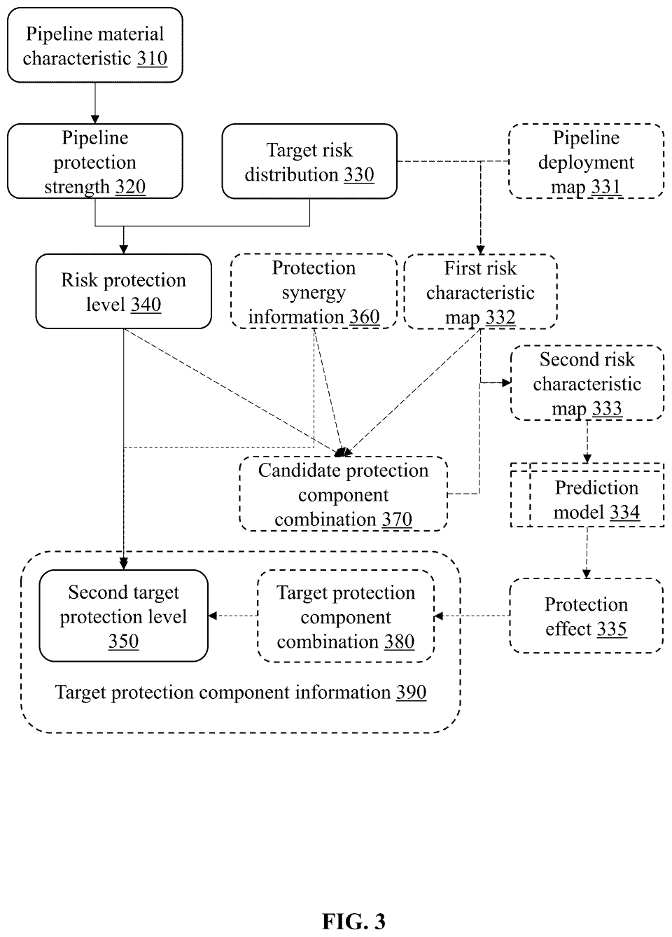

In some embodiments, the gas company management platform 130-1 may be configured to perform a deployment method for a pipeline protection component based on the smart gas IoT as described in any of the embodiments of the present disclosure. More descriptions may be found in FIGS. 2-3.

The gas company sensor network platform 140 refers to a functional platform for sensing communication between the governmental safety monitoring object platform 130 and the gas device object platform 150. The gas company sensor network platform 140 may be configured as a communication network and a gateway. In some embodiments, the gas company sensor network platform 140 may be a server located in the region in which the gas pipelines are deployed.

In some embodiments, the gas company sensor network platform 140 may interact with the gas device object platform 150 and the gas company management platform 130-1. For example, the gas company sensor network platform 140 may obtain environmental information sent by the gas device object platform 150 and transmit the environmental information to the gas company management platform 130-1.

The gas device object platform 150 refers to a functional platform associated with a gas device for sensing information generation and controlling information execution.

In some embodiments, the gas device object platform 150 may be configured to interact with a plurality of devices. The plurality of devices may include the gas device (e.g., a gas meter), a gas monitoring device (e.g., a gas pressure monitoring device, a temperature monitoring device, a flow rate monitoring device), an environmental protection facility (e.g., an exhaust gas treatment device, an environmental protection monitoring device), a maintenance device (e.g., an overhaul device, a cleaning device, etc.), or the like. In some embodiments, the gas device object platform 150 may include a plurality of gas pipelines and a sensing device for acquiring the environmental information of the region where the plurality of gas pipelines are located.

In some embodiments, the gas device object platform 150 may interact with the gas company sensor network platform 140. For example, the gas device object platform 150 may obtain a valve control instruction issued by the gas company management platform 130-1 via the gas company sensor network platform 140, and regulate a gas delivery pressure of at least one gas pipeline in the target region based on the valve control instruction.

It should be noted that the foregoing description of the smart gas IoT 100 is intended to be exemplary and illustrative only and does not limit the scope of application of the present disclosure.

FIG. 2 is an exemplary flowchart illustrating a process of a deployment method for a pipeline protection component based on a smart gas IoT according to some embodiments of the present disclosure. In some embodiments, process 200 may be performed by the gas company management platform 130-1 of the smart gas IoT 100. More descriptions regarding the platforms may be found in FIG. 1 and related descriptions thereof. As shown in FIG. 2, process 200 may include the following operations.

In 210, obtaining, via a gas company sensor network platform, environmental information of a target region during a plurality of first preset time periods from a sensing device arranged in a gas device object platform.

More descriptions regarding the gas company sensor network platform and the gas device object platform may be found in FIG. 1 and relate descriptions thereof.

The target region refers to a region where a gas pipeline protection component is to be deployed. The gas company management platform may determine the target region based on pre-stored construction information in a database (e.g., the governmental monitoring integrated database 110-1).

The first preset time period refers to a period of time that is predetermined. The first preset time period may be a historical time period before a current moment. In some embodiments, the first preset time period may include a plurality of time points.

The environmental information refers to information related to an environment of the target region. The environmental information during the first preset time period may include information obtained at a plurality of time points during the first preset time period, and is related to the environment of the target region. In some embodiments, the environmental information may include temperature information, humidity information, geological information, and vibration information.

The temperature information refers to information related to a temperature of the target region. In some embodiments, the temperature information may include an average temperature, a maximum temperature, and a minimum temperature. The average temperature refers to an average value of the temperatures acquired at a plurality of time points during the first preset time period. The maximum temperature refers to the highest temperature acquired at the plurality of time points during the first preset time period. The minimum temperature refers to the lowest temperature acquired at the plurality of time points during the first preset time period.

The humidity information refers to information related to a humidity level of the target region. In some embodiments, the humidity information may include an average humidity level, a maximum humidity level, and a minimum humidity level. The average humidity level, the maximum humidity level, and the minimum humidity level are similar to the average temperature, the maximum temperature, and the minimum temperature, and are not described herein.

The geological information refers to information related to a geological condition of the target region. In some embodiments, the geological information may include a soil density distribution and a soil potential of Hydrogen (pH) distribution. The soil density distribution includes an average value of soil densities of each of a plurality of acquisition points acquired at the plurality of time points during the first preset time period and position information corresponding to the average value of soil densities. The soil pH distribution includes an average value of soil pH values of each of the plurality of acquisition points acquired at the plurality of time points during the first preset time period and position information corresponding the average value of soil pH values.

An acquisition point refers to a point where information acquisition is performed. The acquisition point may be determined by user input.

Merely by way of example, for the geological information, if the first preset time period includes time points t₁, t₂, . . . , and tₙ, a preset acquisition path includes a plurality of acquisition points p₁, . . . , and pₘ, and data is acquired along the preset acquisition path at each of the time points in the first preset time period, then the soil density distribution includes an average value of soil densities of the acquisition point p₁ acquired at the time points t₁, t₂, . . . , and to, an average value of soil densities of the acquisition point p₂ acquired at the time points t₁, t₂, . . . , and to, . . . , and an average value of soil densities of the acquisition point pₘ acquired at the time points t₁, t₂, . . . , and to.

The vibration information refers to information reflecting a land vibration in the target region. In some embodiments, the vibration information may include a vibration intensity distribution and a vibration frequency distribution. The vibration intensity distribution includes an average value of vibration intensities of each of the plurality of acquisition points acquired at the plurality of time points during the first preset time period and position information corresponding to the average value of vibration intensities. The vibration frequency distribution includes an average value of vibration frequencies of each of the plurality of acquisition points acquired at the plurality of time points during the first preset time period and position information corresponding to the average value of vibration frequencies.

In some embodiments, the gas device object platform may obtain the environmental information of the target region during each of the plurality of first preset time periods by the arranged sensing device. The environmental information acquired by the gas device object platform during the plurality of first preset time periods may be transmitted to the gas company management platform via the gas company sensor network platform.

The sensing device refers to a detection device that measures the environmental information. In some embodiments, the sensing device may include a temperature acquisition device (e.g., a temperature sensor), a humidity acquisition device (e.g., a humidity sensor), a geological acquisition device (e.g., a soil detection instrument), a vibration acquisition device (e.g., a vibration sensor), or the like.

In some embodiments, the sensing device may work in a plurality of ways. For example, the sensing device may be arranged at a fixed position for data detection or loaded on a carrier (e.g., a mobile carrier) for data detection, etc.

In some embodiments, the sensing device may be loaded on a crawling robot. The crawling robot may be configured to perform data acquisition along the preset acquisition path.

The crawling robot refers to a robot that is capable of crawling and loading with an object (e.g., the sensing device). The crawling robot may include a robot body and a control system, equipped with a self-contained power-driven system for self-propelled movement. In some embodiments, the crawling robot may be arranged inside the gas pipelines or on the ground corresponding to the gas pipelines.

In some embodiments, the crawling robot may be equipped with an image sensor that transmits inspection data (e.g., an inspection image) to the control system in real-time.

In some embodiments, the crawling robot may follow the preset acquisition path to acquire the environmental information in the target region.

The preset acquisition path refers to a pre-configured path for the crawling robot to acquire information. In some embodiments, the preset acquisition path may include a plurality of acquisition points.

In some embodiments, the preset acquisition path may be determined in a plurality of ways.

In some embodiments, the gas company management platform may determine the preset acquisition path based on a plurality of gas pipeline transportation paths within a pipeline deployment map.

The pipeline deployment map refers to a schematic diagram illustrating the deployment of gas pipelines. The pipeline deployment map may indicate a direction, a size, etc., of each of the gas pipelines. In some embodiments, the pipeline deployment map may be input by a user or may be obtained based on information pre-stored in the governmental monitoring integrated database 110-1. The gas pipeline transportation paths refer to underground paths of the pipelines, which may be directly determined based on the pipeline deployment map. In some embodiments, the gas company management platform may determine the gas pipeline transportation paths as the preset acquisition path.

In some embodiments, the gas company management platform may determine an acquisition parameter of the crawling robot based on the pipeline deployment map and a pipeline importance level of each of a plurality of gas pipeline segments; and determine the preset acquisition path based on the acquisition parameter of the crawling robot.

A gas pipeline segment refers to a segment of a gas pipeline obtained by dividing the gas pipeline. The pipeline deployment map may include a plurality of gas pipeline segments. In some embodiments, the gas pipeline segments may be obtained by dividing a gas pipeline by a relevant staff. In some embodiments, the gas company management platform may divide the gas pipeline based on a length of the gas pipeline to obtain the plurality of gas pipeline segments. For example, the gas company management platform may use an equidistant division manner, i.e., the gas company management platform may divide the gas pipeline into the plurality of gas pipeline segments of the same length.

The pipeline importance level of a gas pipeline segment refers to a level that reflects the importance of the gas pipeline segment. In some embodiments, the pipeline importance level may be preset by a technician based on prior knowledge or historical data.

The acquisition parameter of the crawling robot refers to a parameter of the crawling robot when performing the data acquisition. In some embodiments, the acquisition parameter of the crawling robot may include the acquisition point, a sampling frequency, a sampling amount, or the like, when the data acquisition is performed.

In some embodiments, for each of the gas pipeline segments, the gas company management platform may determine, based on the pipeline importance level of the gas pipeline segment, a count of acquisition points, the sampling frequency, and the sampling amount corresponding to the gas pipeline segment in the target region through a first preset table. The first preset table includes a plurality of pipeline importance levels and the acquisition parameter (e.g., the count of the acquisition points, the sampling frequency, and the sampling amount) of the crawling robot corresponding to each pipeline importance level. In some embodiments, the first preset table may be set by the technician based on experience. In some embodiments, the first preset table may be constructed based on prior knowledge or historical data (e.g., historical acquisition parameters when a historical crawling robot performs the data acquisition of the gas pipeline segments with different pipeline importance levels, etc.).

In some embodiments, the gas company management platform may use a preset algorithm to obtain a shortest path covering all of the acquisition points as the preset acquisition path. For example, the preset algorithm may be a path planning algorithm (e.g., a Dijkstra algorithm, a Best-First-Search (BFS) algorithm, an A* algorithm, etc.).

After determining the preset acquisition path, the gas company management platform may generate a movement instruction and send the movement instruction to the gas device object platform. The gas device object platform may send the movement instruction to the crawling robot.

The movement instruction refers to an instruction that instructs the crawling robot to make a movement. In some embodiments, the gas company management platform may generate an acquisition instruction based on the preset acquisition path of the crawling robot, and send the acquisition instruction to the sensing device loaded on the crawling robot. When the crawling robot moves on the preset acquisition path, the sensing device loaded on the crawling robot may perform the data acquisition based on the acquisition instruction.

In some embodiments of the present disclosure, the sensing device is loaded on the crawling robot, and a preset acquisition path is determined based on the pipeline deployment map and the pipeline importance level of each gas pipeline segment. Therefore, for the gas pipeline segment of a relatively high pipeline importance level, more information may be acquired, and for the gas pipeline segment of a relatively low pipeline importance level, less information may be acquired. As a result the environmental information can be acquired in a more reasonable and efficient way.

In 220, obtaining, via a governmental safety monitoring sensor network platform, biological information, climate information, and facility information of the target region during the plurality of first preset time periods from a governmental safety monitoring management platform.

More descriptions regarding the governmental safety monitoring sensor network platform and the governmental safety monitoring management platform may be found in FIG. 1 and the related descriptions thereof.

The biological information refers to information related to organisms in the target region. In some embodiments, the biological information may include a microbial density distribution, a termite density distribution, a rodent population, or the like. The microbial density distribution includes an average value of microbial densities of each of the plurality of acquisition points acquired at the plurality of time points during the first preset time period, and location information corresponding to the average value of microbial densities. The termite density distribution includes an average value of termite densities of each of the plurality of acquisition points acquired at the plurality of time points during the first preset time periods, and position information corresponding to the average value of termite densities. The rodent population refers to an average value of counts of rodents of the plurality of acquisition points acquired at the plurality of time points during the first preset time period.

The climate information refers to information related to the climate of the target region. In some embodiments, the climate information may include weather types at the plurality of time points during the first preset time period and an occurrence frequency of each of the weather types.

The facility information refers to information related to facilities in the target region. In some embodiments, the facility information may include factory types, a count of factories corresponding to each of the factory types, and a count of facilities. The facilities may include a vehicle, a mechanical device, a site, a pipeline, a communication device, a signaling sign, a houses, or the like.

The factory types may include a chemical factory, a metallurgical processing factory, a heavy machinery processing factory, or the like. In some embodiments, the governmental safety monitoring management platform may acquire the factory types of all factories at the plurality of time points during the first preset time period, determine, for each of the factory types, an average count of factories obtained at the plurality of time points during the first preset time period as the count of factories corresponding to the factory type, and determine an average count of facilities obtained at the plurality of time points during the first preset time period as the count of facilities.

In some embodiments, the governmental safety monitoring management platform may obtain the biological information, the climate information, and the facility information in the target region during the plurality of first preset time periods and transmit the biological information, the climate information, and the facility information to the gas company management platform via the governmental safety monitoring sensor network platform.

In some embodiments, the governmental safety monitoring management platform may periodically obtain the biological information, the climate information, and the facility information of the target region and store the biological information, the climate information, and the facility information in the governmental monitoring integrated database. For example, the governmental safety monitoring management platform may periodically conduct biological statistics, industrial facility statistics, facility statistics, etc., and determine the biological information and the facility information based on results of the statistics. The gas company management platform may retrieve the biological information, the climate information, and the facility information corresponding to each of the first preset time periods through the governmental safety monitoring sensor network platform.

In 230, determining, based on the geological information, the facility information, and the vibration information of the target region during the plurality of first preset time periods, a vibration risk value of the target region during each of the plurality of first preset time periods.

The plurality of first preset time periods may be a plurality of historical time periods before the current moment. Durations of the plurality of first preset time periods may be the same. There may be no intervals between the plurality of first preset time periods, i.e., an end time point of a preceding first preset time period coincides with a start time point of a subsequent first preset time period adjacent to the preceding first preset time period.

The vibration risk value refers to a value that measures a degree of influence of the land vibration on the gas pipelines. In some embodiments, the vibration risk value of the target region during each of the plurality of first preset time periods may include the vibration risk values of the plurality of acquisition points in the target region during each of the plurality of first preset time periods.

In some embodiments, the gas company management platform may determine the vibration risk value of the target region during each of the plurality of first preset time periods in a plurality of ways based on the geological information, the facility information, and the vibration information during the plurality of first preset time periods.

In some embodiments, for each of the first preset time periods, the gas company management platform may determine a vibration amplification factor corresponding to each of the plurality of acquisition points in the first preset time period based on the average value of soil densities of the acquisition point acquired at the plurality of time points in the first preset time period. For example, for each of the plurality of acquisition points, the gas company management platform may divide a vibration factor by an average soil density of the acquisition point to obtain a corresponding vibration amplification factor of the acquisition point. The vibration factor refers to an amplification factor of vibration under a standard soil condition. In some embodiments, the vibration factor may be set based on experience. The vibration amplification factor refers to the amplification factor of the vibration under an actual soil condition corresponding to the acquisition point. The average soil density of an acquisition point may be the average value of the soil densities of the acquisition point acquired at the plurality of time points in the first preset time period.

In some embodiments, for each of the plurality of first preset time periods, the gas company management platform may determine the vibration risk value corresponding to each of the plurality of acquisition points based on the vibration amplification factor, an average vibration intensity of the acquisition point, an average vibration frequency of the acquisition point, an average soil PH value of the acquisition point, the facility information in the target region, or the like. The average soil pH value of an acquisition point may be the average value of the soil pH values of the acquisition point acquired at the plurality of time points during the first preset time period. The average vibration intensity and the average vibration frequency of an acquisition point may be the average value of the vibration intensities and the vibration frequencies of the acquisition point acquired at the plurality of time points during the first preset time period in the vibration information, respectively.

For example, for each of the acquisition points, the gas company management platform may determine the vibration risk value corresponding to the acquisition point based on Equation (1):

$$α = {k}_{11} \times t \times v + {k}_{12} \times \vert r - 7 \vert + {k}_{13} \times ( {q}_{1} + {q}_{2} ) + {k}_{14} \times f , \qquad ( 1 )$$

wherein α denotes the vibration risk value of the acquisition point during the first preset time period, t denotes the vibration amplification factor of the acquisition point, v denotes the average vibration intensity of the acquisition point, r denotes the average soil pH value of the acquisition point, f denotes the average vibration frequency of the acquisition point, q₁ denotes the count of factories, and q₂ denotes the count of facilities. The count of factories and the count of facilities may be obtained from the facility information. k₁₁, k₁₂, k₁₃, and k₁₄ denote weighting factors of a plurality of parameters in calculating the vibration risk value. k₁₁, k₁₂, k₁₃, and k₁₄ may be set based on experience.

In some embodiments, the gas company management platform may determine weighting factors k₁₁, k₁₂, k₁₃, and k₁₄ of the plurality of parameters in calculating the vibration risk value in a plurality of ways. For example, the gas company management platform may determine the weighting factor of the plurality of parameters in calculating the vibration risk value through a first preset regression algorithm.

In some embodiments, the gas company management platform may determine labels of the plurality of parameters, and obtain the weighting factors of the plurality of parameters in calculating the vibration risk value by fitting through the first preset regression algorithm based on the plurality of parameters and the corresponding labels.

For each of the parameters, the gas company management platform may determine a count of vibration-induced failures occurring in the corresponding gas pipeline as the label corresponding to the parameter. The first preset regression algorithm is similar to a third preset regression algorithm, and more descriptions may be found in operation 250 and related descriptions thereof.

In 240, determining, based on the geological information, the biological information, and the facility information of the target region during the plurality of first preset time periods, a corrosion risk value of the target region during each of the plurality of first preset time periods.

The corrosion risk value refers to a value that measures a degree of corrosion risk of the gas pipeline. In some embodiments, the corrosion risk value of the target region during each of the plurality of first preset time periods may include the corrosion risk values of the plurality of acquisition points in the target region during the first preset time period.

In some embodiments, the gas company management platform may determine the corrosion risk value of the target region during each of the plurality of first preset time periods based on the geological information, the biological information, and the facility information during the plurality of first preset time periods in a plurality of ways.

In some embodiments, for each of the first preset time periods, the gas company management platform may determine a soil acidity factor of each of the plurality of acquisition points based on an average soil pH value of the acquisition point. For example, for each of the plurality of acquisition points, the gas company management platform may subtract the average soil PH of the acquisition point from 14 (i.e., the measurement range of pH) to obtain the soil acidity factor of the acquisition point. The soil acidity factor refers to a factor related to the soil pH value. The average soil PH of an acquisition point may be the average value of the soil PH values of the acquisition point acquired at the plurality of time points during the first preset time period in the soil PH distribution.

In some embodiments, for each of the plurality of first preset time periods, the gas company management platform may determine the corrosion risk value for each of the plurality of acquisition points based on the soil acidity factor, a count of factories producing corrosive gases and liquids, an average microbial density of the acquisition point, an average termite density of the acquisition point, an average count of rodents of the acquisition point, or the like. The average microbial density of an acquisition point may be the average value of the microbial densities of the acquisition point acquired at the plurality of time points during the first preset time period in the microbial density distribution. The average termite density of ab acquisition point may be the average value of the termite densities of the acquisition point acquired at the plurality of time points during the first preset time period in the termite density distribution. The average count of rodents of an acquisition point may be the average value of the counts of rodents of the acquisition point acquired at the plurality of time points during the first preset time period in the rodent population. The count of factories producing corrosive gases and liquids may be a count of factories in the factory type that produces corrosive gases and liquids.

For example, for each of the plurality of acquisition points, the gas company management platform may determine the corrosion risk value corresponding to the acquisition point based on Equation (2):

$$β = {k}_{21} \times a + {k}_{22} \times {q}_{3} + {k}_{23} \times ( {b}_{1} + {b}_{2} + {b}_{3} ) , \qquad ( 2 )$$

wherein β denotes the corrosion risk value of the acquisition point during the first preset time period, a denotes the soil acidity factor of the acquisition point, q₃ denotes the count of factories producing corrosive gases and liquids, b₁ denotes the average microbial density, b₂ denotes the average termite density, and b₃ denotes the average count of rodents. k₂₁, k₂₂, and k₂₃ denote weighting factors of a plurality of parameters in calculating the corrosion risk value. k₂₁, k₂₂, and k₂₃ may be set based on experience.

In some embodiments, the gas company management platform may determine the weighting factors k₂₁, k₂₂, and k₂₃ of the plurality of parameters in calculating the corrosion risk value in a plurality of ways. For example, the gas company management platform may determine the weighting factors of the plurality of parameters in calculating the corrosion risk value through a second preset regression algorithm.

In some embodiments, the gas company management platform may determine labels of the plurality of parameters, and determine the weighting factors of the plurality of parameters in calculating the corrosion risk value by fitting though the second preset regression algorithm based on the plurality of parameters and the corresponding labels.

For each of the parameters, the gas company management platform may determine a count of corrosion-induced failures occurring in the corresponding gas pipeline as the label corresponding to the parameter. The second preset regression algorithm is similar to the third preset regression algorithm, and more descriptions may be found in operation 250.

In 250, determining, based on the climate information of the target region during the plurality of first preset time periods, a temperature risk value of the target region during each of the plurality of first preset time periods.

The temperature risk value refers to a value that measures a risk degree of rupture or explosion of the gas pipeline due to a high temperature, a low temperature, etc. In some embodiments, the temperature risk value of the target region during each of the plurality of first preset time periods may include the temperature risk value of the plurality of acquisition points in the target region during each of the plurality of first preset time periods.

In some embodiments, the gas company management platform may determine the temperature risk value of the target region during each of the plurality of first preset time periods based on the climate information during the plurality of first preset time periods in a plurality of ways.

In some embodiments, for each of the first preset time periods, the gas company management platform may determine the temperature risk value of each of the plurality of acquisition points based on the parameters of each of the plurality of acquisition points such as the average temperature, the maximum temperature, the minimum temperature, the average humidity level, a weather risk factor, or the like.

For example, for each of the plurality of acquisition points, the gas company management platform may determine the temperature risk value of the acquisition point based on Equation (3):

$$γ = {k}_{31} \times {t}_{a} + {k}_{32} \times ( {t}_{h} + {t}_{l} ) + {k}_{33} \times {h}_{a} + {k}_{34} \times d , \qquad ( 3 )$$

wherein γ denotes the temperature risk value of the acquisition point during the first preset time period, tₐ denotes the average temperature of the acquisition point during the first preset time period, tₕ denotes the maximum temperature of the acquisition point during the first preset time period, t₁ denotes the minimum temperature of the acquisition point in the first preset time period, hₐ denotes the average humidity level of the acquisition point during the first preset time period, and d denotes the weather risk factor of the acquisition point. k₃₁, k₃₂, k₃₃, and k₃₄ denote the weighting factors of the plurality of parameters in calculating the temperature risk value. k₃₁, k₃₂, k₃₃, and k₃₄ may be set based on experience.

The weather risk factor refers to an average value of products of risk degrees of the weather types and frequencies corresponding to the weather types. In some embodiments, the risk degree of each weather type may be set based on experience.

In some embodiments, the gas company management platform may determine the weighting factors k₃₁, k₃₂, k₃₃, and k₃₄ of the plurality of parameters in calculating the temperature risk value in a plurality of ways. For example, the gas company management platform may set the weighting factors based on experience.

As another example, the gas company management platform may determine the weighting factors for the plurality of parameters in calculating the temperature risk value through the third preset regression algorithm.

In some embodiments, the first preset regression algorithm, the second preset regression algorithm, and the third preset regression algorithm may be the same or different. In some embodiments, the first preset regression algorithm, the second preset regression algorithm, and the third preset regression algorithm may include a linear regression algorithm, a polynomial regression algorithm, a support vector regression algorithm, or the like.

In some embodiments, the gas company management platform may obtain the temperature information and the climate information around the gas pipelines during the corresponding durations of the plurality of the first preset time periods in the historical data.

In some embodiments, the gas company management platform may determine a plurality of pieces of temperature information and a plurality of pieces of climate information, as well as labels of the plurality of pieces of temperature information and the plurality of pieces of climate information, and determine the weighting factors of the plurality of parameters in calculating the temperature risk value by fitting through the third preset regression algorithm based on the plurality of pieces of temperature information, the plurality of pieces of climate information, and the corresponding labels.

For each of the plurality of pieces of temperature information and each of the plurality of pieces of climate information, the gas company management platform may determine a count of failures of the gas pipeline corresponding to the piece of climate information due to a high temperature, a low temperature, etc., as the label corresponding to the piece of climate information.

Merely by way of example, if the labels corresponding to information 1, information 2, and information 3 are y₁, y₂, and y₃, respectively, the three pieces of information include parameters as follows. Information 1 includes an average temperature tₐ₁, a maximum temperature tₕ₁, a minimum temperature tₗ₁, an average humidity level hₐ₁, and a weather risk factor d₁. Information 2 includes an average temperature tₐ₂, a maximum temperature tₕ₂, a minimum temperature tₗ₂, an average humidity level hₐ₂, a weather risk factor d₂. Information 3 includes an average temperature tₐ₃, a maximum temperature tₕ₃, a minimum temperature tₗ₃, an average humidity level hₐ₃, a weather risk factor d₃. The following three equations may be obtained based on Equation (3), and according to the following three equations, the gas company management platform may execute a regression algorithm, and obtain the weighting factors k₃₁, k₃₂, k₃₃, and k₃₄ by fitting.

$${k}_{31} \times {t}_{a 1} + {k}_{32} \times ( {t}_{h 1} - {t}_{l 1} ) + {k}_{33} \times {h}_{a 1} + {k}_{34} \times {d}_{1} = {y}_{1}$$

$${k}_{31} \times {t}_{a 2} + {k}_{32} \times ( {t}_{h 2} - {t}_{l 2} ) + {k}_{33} \times {h}_{a 2} + {k}_{34} \times {d}_{2} = {y}_{2}$$

$${k}_{31} \times {t}_{a 3} + {k}_{32} \times ( {t}_{h 3} - {t}_{l 3} ) + {k}_{33} \times {h}_{a 3} + {k}_{34} \times {d}_{3} = {y}_{3}$$

The weighting factors of the parameters for the corrosion risk value and the vibration risk value may be determined in a similar manner.

In some embodiments of the present disclosure, determining the weighting factors of the plurality of parameters in calculating the vibration risk value, the corrosion risk value, and the temperature risk value through the first preset regression algorithm, the second preset regression algorithm, and the third preset regression algorithm can improve the accuracy of the weighting factors, thereby improving the reliability of the vibration risk value, the corrosion risk value, and the temperature risk value obtained by calculation.

In some embodiments, the gas company management platform may determine the corrosion risk value based on the temperature risk value, the geological information, the biological information, and the facility information.

In some embodiments, the gas company management platform may further consider the temperature risk value and the weighting factor corresponding to the temperature risk value. For example, a weighting term corresponding to the temperature risk value is added to Equation (2) to obtain Equation (4):

$$β = {k}_{21} \times a + {k}_{22} \times {q}_{3} + {k}_{23} \times ( {b}_{1} + {b}_{2} + {b}_{3} ) + {k}_{24} \times γ , \qquad ( 4 )$$

where γ denotes the temperature risk value of the acquisition point during the first preset time period, and k₂₄ denotes the weighting factor corresponding to the temperature risk value.

In some embodiments, the gas company management platform may determine the weighting factor k₂₄ corresponding to the temperature risk value in a plurality of ways. For example, the gas company management platform may determine a percentage of the temperature risk value among the types of risk values (e.g., the vibration risk value, the corrosion risk value, and the temperature risk value) as the weighting factor k₂₄ corresponding to the temperature risk value.

In some embodiments, the gas company management platform may determine the vibration risk value based on the corrosion risk value, the geological information, the facility information, and the vibration information.

In some embodiments, the gas company management platform may further consider the corrosion risk value and the weighting factor corresponding to the corrosion risk value. For example, a weighting term corresponding to the corrosion risk value is added to Equation (1) to obtain Equation (5):

$$α = {k}_{11} \times t \times v + {k}_{12} \times \vert r - 7 \vert + {k}_{13} \times ( {q}_{1} + {q}_{2} ) + {k}_{14} \times f + {k}_{15} \times β , \qquad ( 5 )$$

wherein β denotes the corrosion risk value of the acquisition point during the first preset time period, and k₁₅ denotes a weighting factor corresponding to the corrosion risk value.

In some embodiments, the gas company management platform may determine the weighting factor k₁₅ corresponding to the corrosion risk value in a plurality of ways. For example, the gas company management platform may determine a percentage of the corrosion risk value among the three types of risk values (e.g., the vibration risk value, the corrosion risk value, and the temperature risk value) as the weighting factor k₁₅ corresponding to the corrosion risk value.

In some embodiments, the gas company management platform may determine the weighting factor of the temperature risk value in calculating the corrosion risk value through the second preset regression algorithm, and/or determine the weighting factor of the corrosion risk value in calculating the vibration risk value through the first preset regression algorithm.

That is to say, when the weighting factors of the plurality of parameters in calculating the corrosion risk value are determined through the second preset regression algorithm, the gas company management platform may determine the label corresponding to the temperature risk value and obtain the weighting factors k₂₁, k₂₂, k₂₃, and k₂₄ of the plurality of parameters (including the temperature risk value) in calculating the corrosion risk value by fitting. This principle also applies to the determination of the vibration risk value.

In some embodiments of the present disclosure, by determining the corrosion risk value based on the temperature risk value, the geological information, the biological information, and the facility information, and determining the vibration risk value based on the corrosion risk value, the geological information, the facility information, and the vibration information, it is ensured that the corrosion risk value and the vibration risk value are more reliable, thereby ensuring the reliability of a target risk distribution of the target region.

In 260, determining, based on the vibration risk value, the corrosion risk value, and the temperature risk value of the target region during each of the plurality of first preset time periods, the target risk distribution of the target region.

The target risk distribution refers to risk types (e.g., a vibration risk type, a corrosion risk type, and a temperature risk type) at each of the plurality of acquisition points in the target region and a risk characteristic corresponding to each of the plurality of acquisition points. The vibration risk type refers to a risk due to vibration, the corrosion risk type refers to a risk due to corrosion, and the temperature risk type refers to a risk due to a high temperature or a low temperature. The risk characteristic of an acquisition point may include an average value, a minimum value, and a maximum value of the risk values of each of the risk types at the acquisition point during the plurality of first preset time periods. For example, the risk characteristic may include: an average vibration risk value, a minimum vibration risk value, and a maximum vibration risk value corresponding to each of the plurality of acquisition points during the plurality of first preset time periods; an average corrosion risk value, a minimum corrosion risk value, and a maximum corrosion risk value corresponding to each of the plurality of acquisition points during the plurality of first preset time periods; and an average temperature risk value, a minimum temperature risk value, and a maximum temperature risk value corresponding to each of the plurality of acquisition points during the plurality of first preset time periods, or the like.

In some embodiments, the gas company management platform may determine the target risk distribution of the target region based on the vibration risk value, the corrosion risk value, and the temperature risk value of each of the plurality of acquisition points during the plurality of first preset time periods in a plurality of ways. For example, the gas company management platform may statistically process the risk values (e.g., including the vibration risk value, the corrosion risk value, and the temperature risk value) of each of the plurality of acquisition points during the plurality of first preset time periods to obtain the target risk distribution.

In some embodiments, the gas company management platform may determine an intrinsic risk value corresponding to each of the vibration risk value, the corrosion risk value, and the temperature risk value based on a pipeline operating characteristic and a pipeline material characteristic.

The pipeline operating characteristic refers to a characteristic that indicates a planned pipeline transportation. The planned pipeline transportation refers to a transportation plan designed based on the gas pipeline. In some embodiments, the pipeline operating characteristic may include a gas flow rate and a gas pressure of the planned pipeline transportation.

The pipeline material characteristic refers to a feature related to a material of the pipeline. In some embodiments, the pipeline material characteristic may include a pipeline wall material and a pipeline wall thickness.

In some embodiments, the gas company management platform may obtain the pipeline operating characteristic and the pipeline material characteristic based on the pipeline deployment map.

The intrinsic risk value refers to a value used to measure a risk degree generated by the operation of the gas pipeline itself (e.g., continuous transportation of a high-pressure or high-flow rate gas, etc.). In some embodiments, the intrinsic risk value may include at least one of a vibration intrinsic risk value corresponding to the vibration risk value, a corrosion intrinsic risk value corresponding to the corrosion risk value, and a temperature intrinsic risk value corresponding to the temperature risk value, or any combination thereof.

In some embodiments, the gas company management platform may construct a first feature vector based on the pipeline operating characteristic and the pipeline material characteristic, and match the first feature vector in a first vector database based on the first feature vector to obtain the vibration intrinsic risk value, the corrosion intrinsic risk value, and the temperature intrinsic risk value.

The first vector database includes a plurality of first reference vectors and first vector labels corresponding to the plurality of first reference vectors. The gas company management platform may construct the first reference vectors based on pipeline operating characteristics and pipeline material characteristics in historical data. The first vector label of a first reference vector includes at least one of the vibration intrinsic risk value, the corrosion intrinsic risk value, and the temperature intrinsic risk value corresponding to the first reference vector.

In some embodiments, the gas company management platform may construct the plurality of first reference vectors based on the historical data, and cluster the plurality of first reference vectors. For each of clusters of reference vectors in a clustering result, the gas company management platform may determine a count of gas pipelines that experience failures (e.g., leaks, ruptures, etc.) due to each of the risk types (e.g., the vibration risk type, the corrosion risk type, and the temperature risk type). Then the gas company management platform may determine a ratio of the count of gas pipelines that experience failures under each of the risk types to a sum of the counts of gas pipelines that experience failures under all risk types as a first vector label corresponding to the cluster of first reference vectors. Since causes of gas pipeline failures are traced after pipeline inspection, it is possible to determine the causes of the gas pipeline failures in the historical data.

In some embodiments, for each of the risk types, the gas company management platform may match the first feature vector against the first vector database to identify a first reference vector having a highest vector similarity with the first feature vector, and determine the first vector label corresponding to the first reference vector having the highest vector similarity with the first feature vector as the intrinsic risk value (e.g., the vibration intrinsic risk value, the corrosion intrinsic risk value, and the temperature intrinsic risk value) of the risk type. The vector similarity may be determined based on a vector distance. The vector similarity is negatively correlated to the vector distance.

In some embodiments, the gas company management platform may determine the target risk distribution based on the vibration risk value, the corrosion risk value, the temperature risk value of the target region during each of the plurality of first preset time periods, and the intrinsic risk value corresponding to each of the vibration risk value, the corrosion risk value, the temperature risk value in a plurality of ways.

In some embodiments, for each of the risk types in the risk characteristic of each of the acquisition points in the target region, the gas company management platform may determine an average value of the risk values (as determined in operations 230 to 250) of the risk type at the acquisition point during the plurality of first preset time periods, and then multiply the average value by the intrinsic risk value corresponding to the risk type to obtain the average risk value of the risk type at the acquisition point. For example, for each of acquisition points, the gas company management platform may determine an average value of the vibration risk values at the acquisition point during the plurality of first preset time periods and then multiply the average value by the vibration intrinsic risk value to obtain the average vibration risk value. For each of the acquisition points, the gas company management platform may determine an average value of the corrosion risk values at the acquisition point during the plurality of first preset time periods and then multiply the average value by the corrosion intrinsic risk value to obtain the average corrosion risk value. For each of the acquisition points, the gas company management platform may determine an average value of the temperature risk values at the acquisition point during the plurality of first preset time periods and then multiply the average value by the temperature intrinsic risk value to obtain the average temperature risk value.

In some embodiments, for each of the risk types in the risk characteristic of each of the acquisition points, the gas company management platform may directly designate a highest value and a lowest value of the risk values (as determined in operations 230 to 250) of the risk type at the acquisition point during the plurality of first preset time periods as a highest risk value and a lowest risk value of the risk type in the risk characteristic. For example, the gas company management platform may determine the highest value and lowest value of the vibration risk values during the plurality of first preset time periods as a maximum vibration risk value and a minimum vibration risk value, respectively.

In some embodiments of the present disclosure, determining the target risk distribution through the intrinsic risk value enables estimation of the probability of occurrence of the average risk value corresponding to each of the risk types, thereby making the obtained target risk distribution more accurate.

In some embodiments, the gas company management platform may determine the target risk distribution based on the vibration risk value, the corrosion risk value, and the temperature risk value of the target region during the plurality of first preset time periods, and the intrinsic risk value and a confidence level of the intrinsic risk value corresponding to each of the vibration risk value, the corrosion risk value, and the temperature risk value.

The confidence level of the intrinsic risk value refers to a degree of confidence for the intrinsic risk value. For example, the higher the accuracy of the intrinsic risk value is, the higher the confidence level is.

The intrinsic risk value may be determined in a plurality of ways. In some embodiments, the gas company management platform may determine the vector similarity between the first feature vector and the first reference vector as the confidence level of the intrinsic risk value. The vector similarity may be determined using a distance-based similarity determination technique, a cosines-based similarity determination technique, a Pearson correlation coefficient-based similarity determination technique, or the like.

In some embodiments, for each of the risk types in the risk characteristic of each of the acquisition points in the target region, the gas company management platform may determine an average value of the risk values (as determined in operations 230 to 250) of the risk type during the plurality of first preset time periods, multiply the average value by the intrinsic risk value corresponding to the risk type, then multiply the multiplied value by the confidence level corresponding to the intrinsic risk value, and determine the calculated result as the average risk value of the risk type in the risk characteristic. For example, the gas company management platform may determine an average value of the vibration risk values during the plurality of first preset time periods, multiply the average value by the vibration intrinsic risk value, then multiply the multiplied value by the confidence level of the vibration intrinsic risk value, and determine the calculated result as the average vibration risk value.

In some embodiments of the present disclosure, determining the target risk distribution by the confidence level of the intrinsic risk value can make the obtained target risk distribution more accurate.

In 270, determining, based on the target risk distribution, target protection component information of a target protection component deployed at each of the plurality of acquisition points in the target region.

The target protection component information refers to information related to the deployed pipeline protection component. In some embodiments, the target protection component information may include a target protection component type of the target protection component and a first target protection level corresponding to the target protection component.

The target protection component type refers to a type of the target protection component deployed in the target region. The target protection component type may include a corrosion protection component, an insulation component, a vibration protection component, or the like. In some embodiments, the corrosion protection component may correspond to the corrosion risk type, the insulation component may correspond to the temperature risk type, and the vibration protection component may correspond to the vibration risk type.

The first target protection level refers to a protection level of the target protection component deployed in the target region. The protection level refers to a level of a protection effect that the target protection component may provide.

The first target protection level is related to the target protection component type. The first target protection level may include a protection level of the corrosion protection component, a protection level of the insulation component, and a protection level of the vibration protection component, indicating a level of a corrosion protection effect that the target protection component may provide, a level of an insulation protection effect that the target protection component may provide, and a level of a vibration protection effect that the target protection component may provide, respectively. In some embodiments, the higher the first target protection level is, the better the protection effect is.

In some embodiments, the gas company management platform may determine the target protection component information of the target protection component deployed at the acquisition point in the target region based on the target risk distribution in a plurality of ways.

In some embodiments, for each of the plurality of acquisition points, the gas company management platform may determine the target protection component type of the target protection component deployed at the acquisition point and the first target protection level corresponding to the target protection component through a second preset table. The second preset table includes a plurality of target risk distributions and first target protection levels (e.g., the protection level of the corrosion protection component, the protection level of the insulation component, and the protection level of the vibration protection component) corresponding to each of the plurality of target risk distributions. In some embodiments, the second preset table may be set by the technician based on experience. In some embodiments, the second preset table may be constructed based on prior knowledge or historical data (e.g., first target protection levels required for different historical target risk distributions).

For example, the gas company management platform may look up the protection level of the corrosion protection component, the protection level of the insulation component, and the protection level of the vibration protection component in the second preset table based on the target risk distribution.

More descriptions regarding determining the target protection component information of the target protection component may be found in FIG. 3 and related descriptions thereof.

In 280, determining, based on the target risk distribution and the pipeline deployment map of the target region, a deployment density distribution of the target protection components at the plurality of acquisition points in the target region.

The deployment density distribution includes a count of target protection components deployed in the gas pipeline segments on which the plurality of acquisition points in the target region are located.

In some embodiments, the gas company management platform may determine the deployment density distribution of the target protection components based on the target risk distribution and the pipeline deployment map of the target region in a plurality of ways.

In some embodiments, for each of the plurality of acquisition points in the target region, the gas company management platform may cluster acquisition points in a plurality of gas pipeline deployment regions in the historical data based on the risk characteristic of the acquisition point in the target region, thereby obtaining a plurality of clusters of acquisition points. For each of the plurality of acquisition points in the target region, the gas company management platform may identify, based on a clustering result, acquisition points in the target region that belong to the same cluster as the acquisition point in the target region, and designate an average count of protection components of the component types (e.g., the corrosion protection component, the insulation component, and the vibration protection component) actually used in the acquisition points as the count of pipeline protection components deployed at the acquisition point in the target region.

In 290, before executing a protection component deployment operation, and/or during the execution of the protection component deployment operation, generating a valve control instruction based on the deployment density distribution, and sending the valve control instruction to the gas device object platform to regulate a gas delivery pressure of at least one gas pipeline in the target region.

The valve control instruction refers to a command used to instruct a regulating valve in the gas pipeline to make pressure adjustments.

In some embodiments, the gas company management platform may generate the valve control instruction based on the deployment density distribution in a plurality of ways. For example, for an acquisition point deployed with a relatively small count of protection components, the likelihood of a failure is relatively high. Therefore, the valve control instruction may be generated to reduce the gas pipeline pressure.

In some embodiments, for an acquisition point deployed with a count of protection components exceeding a preset density threshold, the gas company management platform may generate the valve control instruction at a preset interval to regulate the gas pipeline pressure corresponding to the acquisition point, thereby ensuring that the gas pipeline pressure remains within a standard range.

In some embodiments, the preset density threshold and the preset interval may be set based on historical construction experience. For example, the gas company management platform may select a density threshold corresponding to a historical construction case in which no failure occurred throughout the entire process as a current preset density threshold.

The standard range refers to a standard range of the gas pipeline pressure. In some embodiments, the standard range may be set by the technician based on experience.

In some embodiments, the gas company management platform may send the generated valve control instruction to the gas device object platform via the gas company sensor network platform. The gas device object platform may regulate the gas delivery pressure of at least one gas pipeline in the target region based on the valve control instruction. The gas device object platform may control the regulating valve in the gas pipeline to regulate the pressure.

In some embodiments of the present disclosure, deploying appropriate pipeline protection components in key protection regions based on actual conditions during pipeline construction can ensure the service life of the gas pipeline. In addition, adjusting the gas delivery pressure of at least one gas pipeline in the target region based on the valve control instruction can help prevent failures, thereby ensuring the service life of the pipeline and reducing replacement costs.

It should be noted that the foregoing descriptions of process 200 are for illustrative purposes only and do not limit the scope of application of the present disclosure. For those skilled in the art, various corrections and changes can be made to process 200 under the guidance of the present disclosure. However, these corrections and changes remain within the scope of the present disclosure. For example, operations 230, 240, and 250 may be performed synchronously.

FIG. 3 is an exemplary schematic diagram illustrating the determination of target protection component information of a target protection component according to some embodiments of the present disclosure.

In some embodiments, as shown in FIG. 3, for each of a plurality of acquisition points in a target region, the gas company management platform may determine a pipeline protection strength 320 of the acquisition point based on a pipeline material characteristic 310 of the acquisition point, determine a risk protection level 340 of the acquisition point based on the pipeline protection strength 320 of the acquisition point and a target risk distribution 330 of the target region, and determine a second target protection level 350 of the acquisition point based on the risk protection level 340 of the acquisition point.

More descriptions regarding the acquisition point, the pipeline material characteristic, the target region, and the target risk distribution may be found in FIG. 2 and related descriptions thereof.

The pipeline protection strength refers to a protection level of a gas pipeline against each risk type. In some embodiments, the pipeline protection strength may include a vibration protection level, a corrosion protection level, and a high-temperature protection level.

In some embodiments, the gas company management platform may determine the pipeline protection strength via a third preset table. The third preset table includes a plurality of pipeline wall materials, a plurality of pipeline wall thicknesses, and a pipeline protection strength corresponding to each of the pipeline wall materials and the pipeline wall thicknesses. The pipeline wall thicknesses may be expressed as a range.

In some embodiments, the third preset table may be set by the technician based on experience. In some embodiments, the third preset table may be constructed based on prior knowledge or historical data (e.g., historical pipeline protection strengths corresponding to different pipeline wall materials and pipeline wall thicknesses). The gas company management platform may look up the corresponding pipeline protection strength in the third preset table based on the pipeline wall material and the pipeline wall thickness in the pipeline material characteristic.

The risk protection level refers to a required level of protection for the acquisition point.

The risk protection level may be determined in a plurality of ways. In some embodiments, for each of the acquisition points in the target region, the gas company management platform may subtract the corresponding pipeline protection level in the pipeline protection strength of the acquisition point from the first target protection level as determined based on the second preset table in operation 270 to obtain the risk protection level of the acquisition point.

The second target protection level refers to a protection level for each target protection component type obtained by modifying the first target protection level based on the pipeline protection strength. In some embodiments, if the second target protection level is determined based on the first target protection level, the target protection component information includes the target protection component type and the corresponding second target protection level.

The second target protection level may be determined in a plurality of ways. In some embodiments, for each of the plurality of acquisition points, the gas company management platform may determine the risk protection level of the acquisition point as the second target protection level of the acquisition point.

In embodiments of the present disclosure, the second target protection level is determined by determining the pipeline protection strength and the risk protection level, allowing for targeted determination of the target protection levels for different risk types based on the pipeline material characteristic.

In some embodiments, as shown in FIG. 3, the gas company management platform may determine the second target protection level 350 of the acquisition point based on the risk protection level 340 and protection synergy information 350 of a plurality of target protection components.

The protection synergy information includes the protection level of each of the target protection components for each of the risk types. For example, the protection synergy information may include the vibration protection level, the corrosion protection level, and the insulation protection level corresponding to each of the target protection components.

Although different types of protection components are primarily designed to fulfill their respective protection functions, they may also provide a certain degree of additional protection functions due to their structural characteristics. As an example, a level-3 insulation material provides level-3 insulation, and because of a thickness of the insulation material, it may also offer some level of vibration and corrosion protection-such as level-1 vibration protection and level-2 corrosion protection. Therefore, if level-1 vibration protection and level-3 insulation are required, the level-3 insulation material alone may be used to satisfy both the vibration protection and insulation needs.

In some embodiments, the gas company management platform may identify a risk type with a highest risk value in the target risk distribution and obtain a protection level of the protection component corresponding to the risk type for each of the risk types. Based on the protection levels, the gas company management platform may adjust the protection levels of the protection components corresponding to other risk types.

In embodiments of the present disclosure, determining the second target protection level of the acquisition point based on the protection synergy information enables the protection component to protect the risk type with the highest risk value and protect other lower-risk types, thereby reducing protection costs.

In some embodiments, as shown in FIG. 3, the gas company management platform may construct a first risk characteristic map 332 of the target region based on the target risk distribution 330 of the target region and the pipeline deployment map 331, and generate a plurality of candidate protection component combinations 370 corresponding to the acquisition point based on the first risk characteristic map 332, the risk protection level 340, and the protection synergy information 360. F or each of the plurality of candidate protection component combinations 370, the gas company management platform may update the first risk characteristic map 332 based on the candidate protection component combination 370 to obtain a second risk characteristic map 333 corresponding to the candidate protection component combination, and determine a protection effect 335 corresponding to the candidate protection component combination 370 based on the second risk characteristic map 333 through a prediction model 334. Then, the gas company management platform may determine a target protection component combination 380 based on the protection effects 335 corresponding to the plurality of candidate protection component combinations 370, and determine the target protection component information 390 of the acquisition point based on the target protection component combination 380.

More descriptions regarding the pipeline deployment map may be found in FIG. 2 and related descriptions thereof.

The first risk characteristic map refers to a directed graph structure constructed based on a connectivity relationship between the gas pipelines in the pipeline deployment map. The first risk characteristic map may be represented by nodes and edges connecting the nodes. The nodes in the map represent the acquisition points. A node characteristic of a node indicates the risk types of the acquisition point represented by the node and the risk characteristic (i.e., an average value, a minimum value, and a maximum value of the risk values of each of the risk types at the acquisition point during the plurality of first preset time periods) of the acquisition point. The edges in the map indicate connection relationships between the nodes. If the gas pipelines where two nodes are located are directly connected, or if the two nodes are on the same pipeline, there exists a directed edge from an upstream pipeline to a downstream pipeline between the two nodes.

A candidate protection component combination refers to a combination of three risk types of protection components of different levels and materials.

In some embodiments, for each of the nodes in the first risk characteristic map, the gas company management platform may randomly generate a large amount of candidate protection component combinations that satisfy the risk protection level of the acquisition point corresponding to the node. Satisfying the risk protection level means that the protection level of a protection component type, combined with the protection levels of other protection component types for the risk type, satisfy a required risk protection level.

The second risk characteristic map refers to an updated version of the first risk feature graph that incorporates the candidate protection component combinations. Each candidate protection component combination may correspond to one second risk characteristic map.

Differences between the second risk characteristic map and the first risk characteristic map include different node characteristics. In some embodiments, compared to the first risk characteristic map, the node characteristic of a node in the second risk characteristic map may further include types of the candidate protection components used by the node and the protection synergy information of the candidate protection component. The types of the candidate protection components used by the node may be obtained based on the protection synergy information of the candidate protection component combination corresponding to the second risk characteristic map.

In some embodiments, compared to the first risk characteristic map, the node characteristic of the node in the second risk characteristic map may further include a future intrinsic risk value of the acquisition point corresponding to the node.

The future intrinsic risk value refers to an intrinsic risk value in a preset future time period. The preset future time period refers to a subsequent time period after the gas pipeline is built. For example, the preset future time period may be a day, a week, etc., after the gas pipeline is built.

In some embodiments, the gas company management platform may obtain a change value of the pipeline material characteristic in the preset future time period by referencing a second vector database based on environmental information and the pipeline material characteristic, and determine the future intrinsic risk value based on the change value of the pipeline material characteristic in the preset future time period.

The change value of the pipeline material characteristic refers to a change value of the pipeline wall thickness.

In some embodiments, the gas company management platform may construct a second feature vector based on the environmental information and the pipeline material characteristic, and match the second feature vector against the second vector database based on the second feature vector to obtain the change value of the pipeline material characteristic in the preset future time period.

The second vector database includes a plurality of second reference vectors and corresponding second vector labels. The gas company management platform may construct the second reference vectors based on the environmental information near the gas pipeline and the pipeline material characteristic in the historical data. The second vector label of a second reference vector includes the change value of the pipeline material characteristic corresponding to the second reference vector. In some embodiments, the gas company management platform may determine an actual change value of the pipeline wall thickness of a gas pipeline corresponding to a second reference vector in the historical data after the preset future time period as the second vector label corresponding to the second reference vector.

In some embodiments, the gas company management platform may match the second feature vector against the second vector database to identify a second reference vector having a highest vector similarity with the second feature vector, and designate the second vector label corresponding to the second reference vector having the highest vector similarity as the change value of the pipeline material characteristic in the preset future time period.

In some embodiments of the present disclosure, since gas pipelines typically degrade over time, it is necessary to consider the intrinsic risk value after pipeline aging when predicting the protection effect of protection component, in order to ensure the accuracy of the model prediction.

The protection effect of the candidate protection component combination may be measured based on a predicted service life of the gas pipeline and a predicted count of failures during the use of the gas pipeline. For example, the longer the predicted service life of the gas pipeline and the fewer the predicted count of failures during use, the better the protection effect is. Conversely, the shorter the predicted service life of the gas pipeline and the more the predicted count of failures during use, the worse the protection effect is.

In some embodiments, for each of the plurality of candidate protection component combinations, the gas company management platform may predict the protection effect of each node in the second risk characteristic map through a prediction model based on the second risk characteristic map to obtain the protection effect of the candidate protection component combination.

In some embodiments, the prediction model is a machine learning model. For example, the prediction model may be a neural network (NN) model, a graph neural network (GNN) model, or the like.

In some embodiments, as shown in FIG. 3, an input of the prediction model 334 may include the second risk characteristic map 333, and an output of the prediction model 334 may include the protection effect 335 of each node in the second risk characteristic map 333.

In some embodiments, the prediction model may be obtained by training based on training data.

In some embodiments, the gas company management platform may obtain a plurality of training samples with labels to form a training sample set, and perform a plurality of rounds of iterations based on the training sample set.

The training samples may include sample second risk characteristic maps. The training samples may be the sample second risk characteristic maps corresponding to a plurality of gas pipeline deployment regions in the historical data. The gas company management platform may obtain the sample first risk characteristic map based on a historical risk scenario corresponding to the historical data and the pipeline deployment map corresponding to the historical data; and then update the node characteristic of the node in the first risk characteristic map based on the protection component combination that is actually selected in the historical data to obtain the sample second risk characteristic map.

The label of a training sample may be an actual protection effect corresponding to the sample second risk characteristic map in the training sample. The label is an actual service life and a count of failures during use of each of the gas pipelines in the gas pipeline deployment region corresponding to the training samples in the historical data for a future time period starting from a historical moment. The future time period starting from the historical moment is a time period that has already occurred.

In some embodiments, the gas company management platform may input the training sample set into an initial prediction model to perform a plurality of rounds of iterations. Each round of iterations includes selecting one or more training samples from the training sample set, inputting the one or more training samples into the initial prediction model, obtaining one or more model prediction outputs corresponding to the one or more training samples; substituting the one or more model prediction outputs and the labels of the one or more training samples into a predefined loss function to determine a value of the loss function; iteratively updating model parameters of the initial prediction model based on the value of the loss function. When an iteration end condition is satisfied, the iteration is ended to obtain the trained prediction model. The iteration end condition may include convergence of the loss function, a count of iterations reaching a threshold, etc.

In some embodiment of the present disclosure, determining the protection effect by the prediction model can utilize the self-learning capability of the machine learning model to identify patterns from a large amount of historical data. Thus, a relationship between the protection effect of the second risk characteristic map and the corresponding candidate protection component combination is obtained, thereby improving the accuracy and efficiency of determining the protection effect and determining the protection component combination with a better protection effect.

In some embodiments, in the training sample set of the prediction model, a count of training samples corresponding to any one of an environmental type among the a plurality of environmental types exceeds a preset count threshold corresponding to the environment type.

The environment type refers to a type of environment in which the acquisition point corresponding to the node is located. The environment type may include a residential region, an industrial region, a commercial region, or the like. A complexity level of the environmental information of the environmental type refers to a sum of environmental information that includes a microbial density, a termite density, a rodent population, a count of factory types, and a count of facility types.

In some embodiments, the preset count threshold is positively correlated to the complexity level of the environmental information of the environment type.

In the embodiments of the present disclosure, since the environment directly affects the protection effect of the protection component, the greater the complexity level of the environmental information of an environment type is, the larger amount of information is contained in the environmental information of the environment type. Therefore, a larger amount of training samples is required for the environment type to ensure sufficient model training, thereby improving the accuracy of the model's prediction.

In some embodiments, the gas company management platform may determine the protection effect of each of the candidate protection component combinations corresponding to the second risk characteristic map based on the protection effect of each node output by the prediction model. For example, the gas company management platform may determine an average value of the protection effects of the nodes in the second risk characteristic map to obtain the protection effect corresponding to the candidate protection component combination.

In some embodiments, the gas company management platform may select the candidate protection component combination with a best protection effect as the target protection component combination.

In some embodiments, for each of the acquisition points in the target region, the gas company management platform may determine the target protection component type and the second target protection level of the acquisition point based on information (including the target protection component type and the first protection level) related to the protection component recommended for use at the acquisition point included in the target protection component combination, so as to determine the target protection component information of the target protection component at the acquisition point.

In some embodiments of the present disclosure, by constructing the risk characteristic map to predict the protection effect of each of the candidate protection component combinations and selecting the candidate combination with the best protection effect as the target protection component combination, more appropriate target protection component information can be determined, thereby ensuring the service life of the gas pipeline.

One or more embodiments of the present disclosure provide a deployment system for the pipeline protection component based on the smart gas IoT. The system includes the governmental safety monitoring management platform, the governmental safety monitoring sensor network platform, the governmental safety monitoring object platform, the gas company sensor network platform, and the gas device object platform. The governmental safety monitoring object platform includes the gas company management platform. The gas company management platform includes at least one processor and at least one storage device. The at least one storage device is configured to store computer instructions, and the at least one processor is configured to execute at least a portion of the computer instructions to realize the deployment method for the pipeline protection component based on the smart gas IoT as described in any of the above embodiments. The deployment system for the pipeline protection component based on the smart gas IoT may be part of the smart gas IoT.

One or more embodiments of the present disclosure provide a non-transitory computer-readable storage medium. The computer-readable storage medium stores computer instructions, and when a processor executes the computer instructions in the storage medium, the processor implements the deployment method for the pipeline protection component based on the smart gas IoT as described in any one of the above embodiments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A deployment system for a pipeline protection component based on a smart gas Internet of Things (IoT), comprising a governmental safety monitoring management platform, a governmental safety monitoring sensor network platform, a governmental safety monitoring object platform, a gas company sensor network platform, and a gas equipment object platform, wherein
the government safety monitoring object platform includes a gas company management platform;
the gas company management platform includes at least one processor and at least one storage device;
the at least one storage device is configured to store computer instructions;
the at least one processor is configured to execute at least a portion of the computer instructions to:
obtain, via the gas company sensor network platform, environmental information of a target region during a plurality of first preset time periods from a sensing device arranged in the gas equipment object platform, the environmental information including temperature information, humidity information, geological information, and vibration information;
obtain, via the governmental safety monitoring sensor network platform, biological information, climate information, and facility information of the target region during the plurality of first preset time periods from the governmental safety monitoring management platform;
determine, based on the geological information, the facility information, and the vibration information of the target region during the plurality of first preset time periods, a vibration risk value of the target region during each of the plurality of first preset time periods;
determine, based on the geological information, the biological information, and the facility information of the target region during the plurality of first preset time periods, a corrosion risk value of the target region during each of the plurality of first preset time periods;
determine, based on the climate information of the target region during the plurality of first preset time periods, a temperature risk value of the target region during each of the plurality of first preset time periods;
determine, based on the vibration risk value, the corrosion risk value, and the temperature risk value of the target region during each of the plurality of first preset time periods, a target risk distribution of the target region;
determine, based on the target risk distribution, target protection component information of a target protection component deployed at each of a plurality of acquisition points in the target region, the target protection component information including a target protection component type of the target protection component and a first target protection level corresponding to the target protection component;
determine, based on the target risk distribution and a pipeline deployment map of the target region, a deployment density distribution of the target protection components at the plurality of acquisition points in the target region; and
before executing a protection component deployment operation, and/or during the execution of the protection component deployment operation, generate a valve control instruction based on the deployment density distribution, and send the valve control instruction to the gas equipment object platform to regulate a gas delivery pressure of at least one gas pipeline in the target region.

2. The system of claim 1, wherein the sensing device is loaded on a crawling robot, and the crawling robot is configured to perform data acquisition along a preset acquisition path;
the at least one processor is further configured to:
determine, based on the pipeline deployment map and a pipeline importance level of each of a plurality of gas pipeline segments, an acquisition parameter of the crawling robot; and
determine the preset acquisition path and generate an acquisition instruction based on the acquisition parameter of the crawling robot, and send the acquisition instruction to the gas equipment object platform.

3. The system of claim 1, wherein the at least one processor is further configured to:
determine the corrosion risk value based on the temperature risk value, the geological information, the biological information, and the facility information; and
determine the vibration risk value based on the corrosion risk value, the geological information, the facility information, and the vibration information.

4. The system of claim 1, wherein the at least one processor is further configured to:
determine, based on a pipeline operating characteristic and a pipeline material characteristic, an intrinsic risk value corresponding to each of the vibration risk value, the corrosion risk value, and the temperature risk value, the intrinsic risk value being used to measure a risk level generated by an operation of the at least one gas pipeline in the target region;
the determine, based on the vibration risk value, the corrosion risk value, and the temperature risk value of the target region during each of the plurality of first preset time periods, a target risk distribution of the target region, comprising:
determine the target risk distribution based on the vibration risk value, the corrosion risk value, and the temperature risk value of the target region during each of the plurality of first preset time periods and the intrinsic risk value corresponding to each of the vibration risk value, the corrosion risk value, the temperature risk value.

5. The system of claim 4, wherein the at least one processor is further configured to:
determine the target risk distribution based on the vibration risk value, the corrosion risk value, and the temperature risk value of the target region during each of the plurality of first preset time periods, and the intrinsic risk values and a confidence level of each of the intrinsic risk values.

6. The system of claim 1, wherein the at least one processor is further configured to:
for each of the plurality of acquisition points in the target region,
determine a pipeline protection strength of the acquisition point based on a pipeline material characteristic of the acquisition point;
determine, based on the pipeline protection strength of the acquisition point and the target risk distribution of the target region, a risk protection level of the acquisition point; and
determine, based on the risk protection level of the acquisition point, a second target protection level of the acquisition point.

7. The system of claim 6, wherein the at least one processor is further configured to:
determine, based on the risk protection level and protection synergy information of a plurality of target protection components, the second target protection level of the acquisition point.

8. The system of claim 6, wherein the at least one processor is further configured to:
construct, based on the target risk distribution of the target region and the pipeline deployment map of the target region, a first risk characteristic map of the target region;
generate, based on the first risk characteristic map, the risk protection level, and the protection synergy information, a plurality of candidate protection component combinations corresponding to the acquisition point;
for each of the plurality of candidate protection component combinations,
update the first risk characteristic map based on the candidate protection component combination to obtain a second risk characteristic map corresponding to the candidate protection component combination;
determine, based on the second risk characteristic map, a protection effect corresponding to the candidate protection component combination through a prediction model, the prediction model being a machine learning model;
determine, based on protection effects corresponding to the plurality of candidate protection component combinations, a target protection component combination; and
determine, based on the target protection component combination, the target protection component information of the target protection component at the acquisition point.

9. The system of claim 8, wherein the prediction model is obtained through a training process based on a set of training samples, and the training process includes:
obtaining a plurality of training samples with labels to form the training sample set, and performing a plurality of iterations based on the training sample set, wherein each of the training samples includes a sample second risk characteristic map, the label of the training sample is a protection effect corresponding to the sample second risk characteristic map, and at least one iteration includes:
selecting one or more training samples from the training sample set, inputting the one or more training samples into an initial prediction model, and obtaining a model prediction output corresponding to the one or more of the training samples;
substituting the model prediction output corresponding to the one or more training samples and the labels corresponding to the one or more training samples into a predefined loss function to determine a value of the loss function; and
iteratively updating model parameters of the initial prediction model based on the value of the loss function, ending the iteration until an iteration termination condition is satisfied, and obtaining the prediction model, wherein the iteration termination condition includes convergence of the loss function or a count of the iteration reaching an iteration count threshold.

10. A deployment method for a pipeline protection component based on a smart gas Internet of Things (IoT), the method being executed by a gas company management platform of a deployment system for the pipeline protection component, and the method comprising:
obtaining, via a gas company sensor network platform, environmental information of a target region during a plurality of first preset time periods from a sensing device arranged in a gas equipment object platform, the environmental information including temperature information, humidity information, geological information, and vibration information;
obtaining, via a governmental safety monitoring sensor network platform, biological information, climate information, and facility information of the target region during the plurality of first preset time periods from a governmental safety monitoring management platform;
determining, based on the geological information, the facility information, and the vibration information of the target region during the plurality of first preset time periods, a vibration risk value of the target region during each of the plurality of first preset time periods;
determining, based on the geological information, the biological information, and the facility information of the target region during the plurality of first preset time periods, a corrosion risk value of the target region during each of the plurality of first preset time periods;
determining, based on the climate information of the target region during the plurality of first preset time periods, a temperature risk value of the target region during each of the plurality of first preset time periods;
determining, based on the vibration risk value, the corrosion risk value, and the temperature risk value of the target region during each of the plurality of first preset time periods, a target risk distribution of the target region;
determining, based on the target risk distribution, target protection component information of a target protection component deployed at each of a plurality of acquisition points in the target region, the target protection component information including a target protection component type of the target protection component and a first target protection level corresponding to the target protection component;
determining, based on the target risk distribution and a pipeline deployment map of the target region, a deployment density distribution of the target protection components at the plurality of acquisition points in the target region; and
before executing a protection component deployment operation, and/or during the execution of the protection component deployment operation, generating a valve control instruction based on the deployment density distribution, and sending the valve control instruction to the gas equipment object platform to regulate a gas delivery pressure of at least one gas pipeline in the target region.

11. The method of claim 10, wherein the sensing device is loaded on a crawling robot, and the crawling robot is configured to perform data acquisition along a preset acquisition path, wherein
the preset acquisition path is determined by a process including:
determining, based on the pipeline deployment map and a pipeline importance level of each of a plurality of gas pipeline segments, an acquisition parameter of the crawling robot; and
determining the preset acquisition path and generating an acquisition instruction based on the acquisition parameter of the crawling robot, and sending the acquisition instruction to the gas equipment object platform.

12. The method of claim 10, further comprising:
determining the corrosion risk value based on the temperature risk value, the geological information, the biological information, and the facility information; and
determining the vibration risk value based on the corrosion risk value, the geological information, the facility information, and the vibration information.

13. The method of claim 10, further comprising:
determining, based on a pipeline operating characteristic and a pipeline material characteristic, an intrinsic risk value corresponding to each of the vibration risk value, the corrosion risk value, and the temperature risk value, the intrinsic risk value being used to measure a risk level generated by an operation of the at least one gas pipeline in the target region;
the determining, based on the vibration risk value, the corrosion risk value, and the temperature risk value of the target region during each of the plurality of first preset time periods, a target risk distribution of the target region, including:
determining the target risk distribution based on the vibration risk value, the corrosion risk value, and the temperature risk value of the target region during each of the plurality of first preset time periods, and the intrinsic risk value corresponding to each of the vibration risk value, the corrosion risk value, the temperature risk value.

14. The method of claim 13, further comprising:
determining the target risk distribution based on the vibration risk value, the corrosion risk value, and the temperature risk value of the target region during each of the plurality of first preset time periods, and the intrinsic risk values and a confidence level of each of the intrinsic risk values.

15. The method of claim 10, wherein the determining, based on the target risk distribution, target protection component information of a target protection component deployed at an acquisition point in the target region includes:
for each of the plurality of acquisition points in the target region,
determining a pipeline protection strength of the acquisition point based on a pipeline material characteristic of the acquisition point;
determining, based on the pipeline protection strength of the acquisition point and the target risk distribution of the target region, a risk protection level of the acquisition point; and
determining, based on the risk protection level of the acquisition point, a second target protection level of the acquisition point.

16. The method of claim 15, wherein the determining, based on the risk protection level of the acquisition point, a second target protection level of the acquisition point includes:
determining, based on the risk protection level and protection synergy information of a plurality of target protection components, the second target protection level of the acquisition point.

17. The method of claim 16, further comprising:
constructing, based on the target risk distribution of the target region and the pipeline deployment map of the target region, a first risk characteristic map of the target region;
generating, based on the first risk characteristic map, the risk protection level, and the protection synergy information, a plurality of candidate protection component combinations corresponding to the acquisition point;
for each of the plurality of candidate protection component combinations,
updating the first risk characteristic map based on the candidate protection component combination to obtain a second risk characteristic map corresponding to the candidate protection component combination;
determining, based on the second risk characteristic map, a protection effect corresponding to the candidate protection component combination through a prediction model, the prediction model being a machine learning model;
determining, based on protection effects corresponding to the plurality of candidate protection component combinations, a target protection component combination; and
determining, based on the target protection component combination, the target protection component information of the target protection component at the acquisition point.

18. The method of claim 17, wherein the prediction model is obtained through a training process based on a set of training samples, and the training process includes:
obtaining a plurality of training samples with labels to form the training sample set, and performing a plurality of iterations based on the training sample set, wherein each of the training samples includes a sample second risk characteristic map, the label of the training sample is a protection effect corresponding to the sample second risk characteristic map, and at least one iteration includes:
selecting one or more training samples from the training sample set, inputting the one or more training samples into an initial prediction model, and obtaining a model prediction output corresponding to the one or more of the training samples;
substituting the model prediction output corresponding to the one or more training samples and the labels corresponding to the one or more training samples into a predefined loss function to determine a value of the loss function; and
iteratively updating model parameters of the initial prediction model based on the value of the loss function, ending the iteration until an iteration termination condition is satisfied, and obtaining the prediction model, wherein the iteration termination condition includes convergence of the loss function or a count of the iteration reaching an iteration count threshold.

19. A non-transitory computer-readable storage medium storing computer instructions, wherein when a processor executes the computer instructions, the processor implements a method for pipeline protection component deployment based on a smart gas Internet of Things (IoT), the method comprising:
obtaining, via a gas company sensor network platform, environmental information of a target region during a plurality of first preset time periods from a sensing device arranged in a gas equipment object platform, the environmental information including temperature information, humidity information, geological information, and vibration information;
obtaining, via a governmental safety monitoring sensor network platform, biological information, climate information, and facility information of the target region during the plurality of first preset time periods from a governmental safety monitoring management platform;
determining, based on the geological information, the facility information, and the vibration information of the target region during the plurality of first preset time periods, a vibration risk value of the target region during each of the plurality of first preset time periods;
determining, based on the geological information, the biological information, and the facility information of the target region during the plurality of first preset time periods, a corrosion risk value of the target region during each of the plurality of first preset time periods;
determining, based on the climate information of the target region during the plurality of first preset time periods, a temperature risk value of the target region during each of the plurality of first preset time periods;
determining, based on the vibration risk value, the corrosion risk value, and the temperature risk value of the target region during each of the plurality of first preset time periods, a target risk distribution of the target region;
determining, based on the target risk distribution, target protection component information of a target protection component deployed at each of a plurality of acquisition points in the target region, the target protection component information including a target protection component type of the target protection component and a first target protection level corresponding to the target protection component;
determining, based on the target risk distribution and a pipeline deployment map of the target region, a deployment density distribution of the target protection components at the plurality of acquisition points in the target region; and
before executing a protection component deployment operation, and/or during the execution of the protection component deployment operation, generating a valve control instruction based on the deployment density distribution, and sending the valve control instruction to the gas equipment object platform to regulate a gas delivery pressure of at least one gas pipeline in the target region.
